(19) United States
(12) Patent Application Publication
(10) Pub. No.: US 2004/0242765 A1
(43) Pub. Date: Dec. 2, 2004

(54) Aqueous polyurethane dispersions for producing coatings with soft feel effect

(76) Inventors: Thomas Munzmay, Dormagen (DE); Martin Melchiors, Leichlingen (DE); Jurgen Meixner, Krefeld (DE); Reinhard Halpaap, Odenthal (DE); Torsten Pohl, Koln (DE); Uwe Klippert, Burscheid (DE)

Correspondence Address: BAYER MATERIAL SCIENCE LLC, 100 BAYER ROAD, PITTSBURGH, PA, 15205, US

(21) Appl. No.: 10/854,371

(22) Filed: May 26, 2004

(30) Foreign Application Priority Data
May 30, 2003 (DE) 10324306.2

(51) Int. Cl. C08J 3/00

(52) U.S. Cl. 524/589

(57) ABSTRACT

Coating compositions based on aqueous polyurethane dispersions, a process for preparing such compositions and their use for producing soft feel coatings having low fog and VOC values. The aqueous coating compositions include at least one aqueous formulation of an ionically modified, substantially hydroxyl-free poylurethane and/or polyurethaneurea, at least one aqueous formulation of an ionically modified, hydroxyl-containing polyuerthane and/or polyurethaneurea, and at least on crosslinker.

### CROSS REFERENCE TO RELATED PATENT APPLICATION

The present patent application claims the right of priority under 35 U.S.C. § 119 (a)-(d) of German Patent Application No.103 23 306.2, filed May 30, 2003.

### FIELD OF THE INVENTION

The invention relates to new coating compositions based on aqueous polyurethane dispersions, to a process for preparing them and to their use for producing soft feel coatings having low fog and VOC values.

### BACKGROUND OF THE INVENTION

Ionically modified polyurethanes (PUs) and their aqueous formulations are diversely described in the prior art. An overview of various aqueous PU products and of processes for preparing them are described for example in “Houben-Weyl: Methoden der Organischen Chemie, Volume E 20, pp. 1659-1692” or in “Ullmann's Encyclopedia of Industrial Chemistry (1992) Vol. A21, pp. 677-682”. By virtue of their mechanical strength, high adhesion to different substrates, solvent resistance and gloss they find broad application in the coating of plastics, for example.

When plastics parts are used, for example, in a car interior, however, the effect known as “fogging” or “fog” occurs. This refers to the formation of a deposit which refracts light strongly and which occurs on the interior surfaces of windows, especially the windscreen. The agents responsible are low molecular mass constituents of the plastics parts, which over time, aided by insolation and heat, migrate and deposit on the interior surfaces of the windows. A substantial lessening of this effect can be achieved through the use of “low-fogging” polyurethanes, as are described, for example, in EP-A 579 988, U.S. Pat. No. 5,545,675 or EP-A 1 153 951.

In order to improve the tactile properties of plastics parts, particularly in the car interior, use has been made increasingly in recent years of what are called soft feel coatings.

“Soft feel effect” for the purposes of the present invention denotes a particular tactual sensation (tactility) of the coated surface; this tactility can be described using terms such as velvety, soft, rubberlike, warm whereas, for example, the surface of a painted car body or else an unpainted polymer sheet or one coated with a customary clearcoat or topcoat material and made, for example, of ABS, Makrolon® (polycarbonate, Bayer AG) or Plexiglas® (polymethyl methacrylate) feels cold and smooth. In tune with the trend of avoiding solvent emissions to the environment, recent years have seen the establishment of aqueous soft feel coatings based on the polyurethane chemistry, as disclosed, by way of example, in the teaching of DE-A 44 06 159. As well as an excellent soft feel effect, these coatings also have good resistance and protection for the plastics substrate. It has since been found, however, that even these coating materials and coatings, not least owing to their increased deployment in car interiors, make a notable contribution to the fogging effect.

Low-fogging soft feel coating materials based on aqueous polyurethane systems are presently unknown, and so the object of the present invention was to provide new aqueous coating compositions for producing soft feel coatings having particularly low fog and VOC values.

### SUMMARY OF THE INVENTION

The present invention is directed to aqueous coating compositions that include

A) at least one aqueous formulation of an ionically modified, substantially hydroxyl-free polyurethane and/or polyurethaneurea,

B) at least one aqueous formulation of an ionically modified, hydroxyl-containing polyurethane and/or polyurethaneurea, and

C) at least one crosslinker.

Component A) is synthesized from

A1) one or more polyhydroxyl compounds having a number-average molecular weight (Mₙ)≧500 daltons and an average OH functionality of ≧1.5, substantially free of components volatile at a temperature ≧150° C. and a pressure ≦10 mbar,

A2) optionally one or more polyhydroxyl compounds having a number-average molecular weight (Mₙ) of from 62 to 499 daltons and an OH functionality of ≧2,

A3) optionally one or more hydrophilic compounds having an ethylene oxide content of 50% by weight and a number-average molecular weight (Mₙ) of more than 400 daltons, which contain at least one NCO-reactive group,

A4) one or more polyisocyanates,

A5) optionally one or more aliphatic polyamines having a number-average molecular weight (Mₙ) of from 60 to 300 daltons and at least two primary or secondary amino groups or hydrazine and

A6) one or more compounds containing at least one NCO-reactive hydrogen atom or at least one NCO group and simultaneously at least one ionic or potentially ionic group and different from the aforementioned compounds of compounds A1)-A5).

The present invention is also directed to coatings obtainable from aqueous coating compositions described above and substrates coated with such coatings.

The present invention is further directed to soft feel coating materials that include the polyhydroxy compounds described above as component A1).

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been possible to achieve the object on which the invention is based through the use of special polyesterpolyols pretreated by distillation.

The present invention provides aqueous coating compositions comprising

A) At least one aqueous formulation of an ionically modified, substantially hydroxyl-free polyurethane and/or polyurethaneurea,

B) At least one aqueous formulation of an ionically modified, hydroxyl-containing polyurethane and/or polyurethaneurea and

C) At least one crosslinker,

D) Optionally auxiliaries and additives

characterized in that component A) is synthesized from

A1) one or more polyhydroxyl compounds having a number-average molecular weight (Mₙ)≧500 daltons and an average OH functionality of ≧1.5, which have been freed at a temperature ≧150° C. and a pressure ≦10 mbar from components volatile under these distillation conditions,

A2) optionally one or more polyhydroxyl compounds having a number-average molecular weight (Mₙ) of from 62 to 499 daltons and an OH functionality of ≧2,

A3) optionally one or more hydrophilic compounds having an ethylene oxide content of 50% by weight and a number-average molecular weight (Mₙ) of more than 400 daltons, which contain at least one NCO-reactive group,

A4) one or more polyisocyanates,

A5) optionally one or more aliphatic polyamines having a number-average molecular weight (Mₙ) of from 60 to 300 daltons and at least two primary or secondary amino groups or hydrazine and

A6) one or more compounds containing at least one NCO-reactive hydrogen atom or at least one NCO group and simultaneously at least one ionic or potentially ionic group and different from the aforementioned compounds of compounds A1)-A5)

and also a process for preparing them.

By substantially hydroxyl-free for the purposes of the present invention is meant an OH number of less than 6 mg KOH/g, preferably less than 2.5 mg KOH/g.

By ionic groups for the purposes of the present invention are meant functional groups which carry a positive or negative charge such as, for example, —COO⁻, —SO₃⁻, —NR₂H⁺, —NH₃⁺. As used herein, the terms ionically modified polyurethane or polyurethane urea refer to polyurethanes or polyurethane ureas that have been treated or reacted or modified in some way so as to contain such ionic groups.

By potentially ionic groups for the purposes of the present invention are meant functional groups having covalent bonds which as a function of the pH of their solution are readily convertible into the corresponding salts by addition of base or acid, e.g. —COOM, —SO₃M (where M=H, NR₄⁺, metal ion) or —NR₂/—NR₂H⁺, or —NH₂/—NH₃⁺.

As compounds of component A1) it is preferred to use organic compounds having a number-average molecular weight (Mₙ) of from 500 to 10 000 daltons, more preferably from 600 to 5 000 daltons, very preferably from 1000 to 3000 daltons and an average hydroxyl functionality of preferably from 1.5 to 6, more preferably from 1.8 to 3.

With particular preference the compounds of component A1) are compounds of the aforementioned kind based on polyester, polylactone or polycarbonate and/or the known copolymers.

The compounds for use as A1) in accordance with the invention are freed from volatile components by distillation prior to their use. This distillation is preferably conducted continuously in a thin-film evaporator at temperatures ≧150° C., preferably 170-230° C., more preferably 180-220° C., under a reduced pressure of ≦10 mbar, preferably ≦2 mbar, more preferably ≦0.5 mbar. Low molecular mass, non-reactive volatile fractions are separated from the polyhydroxyl compound under these conditions. In the course of the distillation volatile fractions of 0.2-15% by weight, preferably 0.5-10% by weight, more preferably 1-6% by weight are separated off.

In an embodiment of the invention, the compounds used for A1) are substantially free of low molecular mass, non-reactive volatile fractions. As used herein, substantially free refers to materials being present only as incidental impurities, depending on the specific material, the material will be present at less than 1%, in some cases less than 0.5% and in other cases less than 0.2% by weight based on the weight of a component such as A1).

Suitable polyesterpolyols of component A1) are linear polyesterdiols or branched polyesterpolyols such as may be prepared in known manner from aliphatic, cycloaliphatic or aromatic dicarboxylic or polycarboxylic acids and/or their anhydrides, such as succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic or trimellitic acid and also acid anhydrides, such as o-phthalic, trimellitic or succinic anhydride or mixtures thereof, by reaction with polyhydric alcohols, such as ethanediol, di-, tri-, tetraethylene glycol, 1,2-propanediol, di-, tri-, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol, 2,2,4- and/or 2,4,4-trimethyl-1,3-pentanediol or mixtures thereof, optionally with the use of minor amounts of higher polyfunctional polyols, such as trimethylolpropane, glycerol or pentaerythritol. Suitable polyhydric alcohols for preparing the polyesterpolyols also include aromatic di- and polyhydroxyl compounds. The di- and polyhydroxyl compounds can be used in any desired mixtures, preference being given to the lineraraliphatic and/or cycloaliphatic polyhydroxyl compounds. In place of the free polycarboxylic acids or of the corresponding polycarboxylic anhydrides it is also possible to use corresponding polycarboxylic esters of lower alcohols or mixtures thereof to prepare the polyesters.

The polyesterpolyols can also of course be homopolymers or copolymers of lactones, which are obtained preferably by addition reaction of lactones or lactone mixtures, such as butyrolactone, ε-caprolactone and/or methyl-ε-caprolactone, with suitable difunctional and/or higher polyfunctional starter molecules, such as the low molecular mass polyhydric alcohols mentioned above as synthesis components for polyesterpolyols, for example.

Hydroxyl-containing polycarbonates are also suitable as polyhydroxyl components, examples being those preparable by reacting diols such as 1,4-butanediol and/or 1,6-hexanediol with diaryl carbonates, e.g. diphenyl carbonate, dialkyl carbonate, such as dimethyl carbonate, or phosgene.

Especially preferred compounds of component A1) are polyesterdiols based on adipic acid and glycols such as 1,4-butanediol, 1,6-hexanediol and/or 2,2-dimethyl-1,3-propanediol (neopentyl glycol) and also copolymers of 1,6-hexanediol with ε-caprolactone and diphenyl carbonate and also 1,6-hexanediol-polycarbonatediols.

In addition to the polyols of the aforementioned kind component A1) may also include up to 50% by weight of polyetherpolyols known per se from polyurethane chemistry, such as the polyadducts of styrene oxides, as ethylene oxide, propylene oxide, tetrahydrofuran, butylene oxide, of epichlorohydrin, and also their mixed addition products and graft products, and also the polyols obtained by condensing polyhydric alcohols or mixtures thereof and the polyols obtained by alkoxylating polyfunctional alcohols, amines and amino alcohols. Preferably, however, A1) contains no polyetherpolyols.

The invention further provides for the use of polyhydroxy compounds according to A1) in soft feel coating materials.

Compounds of component A2) are low molecular mass polyols from a number-average molecular weight range Mₙ=62 to 499 daltons. Suitable examples include the polyhydric, especially dihydric, alcohols mentioned above for the preparation of the polyesterpolyols of component A1) and also, moreover, low molecular mass polyesterdiols, such as bis(hydroxyethyl) adipate, for example, or short-chain homoaddition and mixed addition products of ethylene oxide or of propylene oxide which are prepared starting from aromatic diols.

Preferred compounds of component A2) are 1,2-ethanediol, 1,4-butanediol, 1,6-hexanediol, 2,2-dimethyl-1,3-propanediol, trimethylolpropane and glycerol, particular preference being given to 1,4-butanediol and 1,6-hexanediol.

Suitable hydrophilic compounds of component A3) to be used as well optionally have a number-average molecular weight of at least 400 daltons, preferably of at least 500 daltons and more preferably of from 1200 to 4500 daltons and correspond to the formula (I),

H—Y′—X—Y—R (I)

in which

R is a monovalent hydrocarbon radical having 1 to 12 carbon atoms, preferably an unsubstituted alkyl radical having 1 to 4 carbon atoms,

X is a polyalkylene oxide chain having 5 to 90, preferably 20 to 70, monomer units and the ethylene oxide content is at least 50% by weight, preferably at least 65% by weight, based on the compound of the formula (I),

Y and Y′ independently of one another are oxygen or —NR′—, where R′ corresponds in terms of its definition to R or hydrogen.

The group X can contain, besides ethylene oxide, also propylene oxide, butylene oxide and/or styrene oxide units; a preferred comonomer is propylene oxide.

The aforementioned monofunctional, hydrophilic polyethers are prepared in analogy to those in DE-A 2 314 512, 2 314 513 or U.S. Pat. Nos. 3,905,929, 3,920,598 by alkylating a monofunctional starter such as n-butanol or N-methylbutylamine, for example, using ethylene oxide and, optionally, a further alkylene oxide such as propylene oxide, for example.

As compounds of component A3) it is preferred to use copolymers of the aforementioned type formed from ethylene oxide and propylene oxide, having an ethylene oxide fraction of more than 50% by weight, more preferably from 55 to 89% by weight, based on the corresponding compound from A3).

Suitable compounds of component A4) include any desired organic compounds, individually or in mixtures with one another, which contain at least two free isocyanate groups per molecule, such as diisocyanates X(NCO)₂, for example, where X is a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon radical having 7 to 15 carbon atoms. Further examples of compounds which can be used as diisocyanate component are described, for example, by W. Siefken in Justus Liebigs Annalen der Chemie, 1949, 562, pp. 75-136.

It is unimportant whether these isocyanates have been prepared by phosgene or phosgene-free processes.

Naturally it is also possible to use the higher polyfunctional polyisocyanates known per se in polyurethane chemistry or else modified polyisocyanates known per se, containing for example carbodiimide, alophanate, isocyanurate, urethane, biuret and/or iminooxadiazinedinone groups, as compounds of component A4), proportionally where appropriate.

Preference is given to using tetramethylene diisocyanate, methylpentamethylene diisocyanate, hexamethylene diisocyanate (HDI), dodecamethylene diisocyanate, 1,4-diisocyanatocyclohexane, 1-isocyanato-3,3,5-trimethyl-5-isocyanatomethyl-cyclohexane (isophorone diisocyanate, IPDI), 2,4′- and/or 4,4′-diisocyanato-dicycloheylmethane, 2,2-bis(4-isocyanatocyclohexyl)propane, 1,4-diisocyanato-benzene, 2,4-diisocyanatotoluene, 2,6-diisocyanatotoluene, 4,4′-diisocyanato-diphenylmethane, 2,2′- and 2,4′-diisocyanatodiphenylmethane, 1,3-(bis-2-isocyanatoprop-2-yl)benzene (TMXDI), 1,3- and 1,4-diisocyantomethyl-benzene (XDI), and mixtures of these compounds. Particular preference is given to hex amethylene diisocyanate, 1-isocyanato-3,3,5-trimethyl-5-isocyanatomethyl-cyclohexane and 2,4′- and/or 4,4′-diisocyanatodicyclohexylmethane or modified oligomeric polyisocyanates of the type mentioned above.

Suitable compounds of component A5) include aliphatic and/or alicyclic primary and/or secondary polyamines having at least 2 primary or secondary amino functions, individually or in mixtures. Those suitable include not only low molecular mass polyamines such as 1,2-ethanediamine, 1,6-hexamethylenedi-amine, 1-amino-3,3,5-trimethyl-5-aminomethylcyclohexane (isophoronediamine), piperazine 1,4-diaminocyclohexane, bis-(4-aminocyclohexyl)methane, adipic dihydrazide or diethylenetriamine and also hydrazine or hydrazine hydrate but also polyether polyamines, which come about formally by replacement of the hydroxyl groups in the above-described polyether polyols with amino groups. Polyether polyamines of this kind can also be prepared by reacting the corresponding polyether polyols with ammonia and/or primary amines.

Preference is given to 1,2-ethanediamine, 1,6-hexamethylenediamine, 1-amino-3,3,5-trimethyl-5-aminomethylcyclohexane (isophoronediamine), piperazine 1,4-diaminocycloheane, bis(4-aminocyclohexyl)methane, adipic dihydrazide or diethylenetriamine and also hydrazine or hydrazine-hydrate, particular preference to 1-amino-3,3,5-trimethyl-5-aminomethylcyclohexane (isophoronediamine), 1,2-ethanediamine, piperazine or diethylenetriamine.

Suitable compounds of component A6) have at least one isocyanato-reactive hydrogen atom or at least one isocyanate group and simultaneously at least one ionic group or one potentially ionic group.

Examples of the compounds in question here include tertiary-amino-containing alcohols, hydroxycarboxylic acids, hydroxysulphonic acids, aminocarboxylic acids or aminosulphonic acids of the type already exemplified in U.S. Pat. No. 3,479,310.

Instead of these synthesis components it is also possible to use the corresponding saltlike derivative, i.e. their quatemization and/or neutralization products. Suitable quaternizing and/or neutralizing agents for converting the potentially ionic groups into ionic groups are likewise mentioned by way of example in U.S. Pat. No. 3,479,310. Where potentially ionic synthesis components are used, the at least partial conversion of the potentially ionic groups into ionic groups by quaternization or neutralization takes place subsequently to or during the preparation of the polyurethanepolyureas.

Preferred compounds of component A6) are those which contain at least two isocyanato-reactive groups in at least one ionic group or one potentially ionic group. Particularly preferred are compounds which in addition to two hydroxyl or two primary or secondary amino groups contain one anionic or potentially anionic group.

Examples of suitable compounds of component A6) are carboxyl- and/or carboxylato-bearing diols such as 2,2-bis(hydroxymethyl)alkanoic acids such as dimethylolacetic acid, dimethylolpropanoic acid, dimethylolbutyric acid, dimethylolpentanoic acid or dihydroxysuccinic acid and also diamines and polyamines bearing sulphonic acid or sulphonate groups.

Very particular preference is given to dimethylolpropionic acid and to the alkali metal salts of N-(2-aminoethyl)-2-aminoethanesulphonic acid.

The inventive component A) can be prepared in accordance with the known preparation processes, as described by, for example, D. Dieterich in Houben-Weyl: Methoden der Organischen Chemie. Volume E20, pp. 1671 to 1681. It is preferred to proceed in accordance with the acetone process described therein.

In the acetone process the synthesis of aqueous formulations of ionically modified polyurethanes and polyurethane ureas takes place in a multi-stage process.

In a first stage a prepolymer containing isocyanate groups is synthesized from synthesis components A1) to A4) and optionally A6). The amounts in which the individual components are used here are such as to result in a ratio of NCO groups to the sum of OH and NH groups (isocyanate index) of from 1.1 to 3.5, preferably from 1.3 to 2. The isocyanate content of the resulting prepolymers is 1.5-7.5% by weight, preferably from 2 to 4.5% by weight and more preferably from 2.5 to 3.5% by weight. Moreover, when calculating the amount of the synthesis components A1) to A4), care should be taken to ensure that the arithmetic, number-average functionality of the prepolymer to be prepared is from 1.80 to 3.50, preferably from 1.95 to 2.25.

In a second stage the prepolymer prepared in stage 1 is dissolved in an organic, at least partly water-miscible solvent which carries no isocyanate-reactive groups, such as acetone, 2-butanone, tetrahydrofuran, dioxane or mixtures of these solvents, for example. A preferred solvent in this context is acetone. The solvent quantities should be such as to result in a solids content of from 30 to 70% by weight, preferably from 35 to 60% by weight, more preferably from 40 to 55% by weight.

In a third stage the isocyanate-containing prepolymer solution from stage 2 is reacted with the amino-functional component A5) and optionally with component A6), if the latter has not yet been added in step 1, or has been added only partly, with chain extension to give the high molecular mass polyurethane resin. The amounts of components A5) and optionally A6) here are calculated so that per mole of isocyanate groups in the dissolved prepolymer there is from 0.3 to 0.93 mol, preferably from 0.5 to 0.85 mol, of isocyanate-reactive groups of components A5) and optionally A6). The arithmetic, number-average isocyanate functionality of the resultant ionically modified polyurethane or polyurethane urea is between 1.55 and 3.10, preferably between 1.90 and 2.35. The arithmetic, number-average molecular weight (Mₙ) is 4500-250 000, preferably 10 000-40 000 daltons.

In a fourth stage the high molecular mass polyurethane resin is precipitated by addition of water in the form of a fine dispersion. The amount of water is calculated such that the formulations following step 5 have a solids content of from 30 to 70% by weight, preferably from 35 to 60% by weight, more preferably from 40 to 55% by weight.

If potentially ionic compounds are employed as synthesis component A6) they must be converted into the ionic form prior to the precipitation of the polymer with water by adding suitable bases or acids. Bases which can be used include tertiary amines such as, for example, triethylamine, triisopropylamine, ethyl-diisopropylamine, triethanolamine or triisopropanolamine or, though less preferably, inorganic bases such as alkali metal or alkaline earth metal hydroxides, carbonates or hydrogen carbonates.

In a fifth stage, organic solvent present is removed completely or partially by distillation, where appropriate under reduced pressure.

The fraction of component A3) is preferably less than 10 mol % based on the amount of the polyisocyanate A4) used, in order to ensure the desired high molecular mass structure of the polyurethane elastomers. Where more than 10% by weight of A3) are used, the concomittant use of trifunctional isocyanate-reactive, components as a constituent of component A2) is of advantage.

In one preferred embodiment of the invention for the preparation of component A) from 30.0 to 83.5 parts by weight of component A1), from 0 to 30 parts by weight, preferably from 0 to 15 parts by weight of component A2), from 0 to 10 parts by weight, preferably from 1 to 10 parts by weight of component A3), from 15 to 50 parts by weight, preferably from 20 to 40 parts by weight of component A4), from 0.5 to 13 parts by weight, preferably from 1 to 5 parts by weight of component A5) and from 1 to 8 parts by weight, preferably from 1.5 to 5.5 parts by weight of component A6) are used in the above-described multi-stage acetone process, the amounts in which the individual components A1)-A6) are used adding up to 100 and the polymeric intermediates and end products obtained corresponding to the specifications given above.

In one particularly preferred embodiment of the invention the abovementioned starting materials are calculated such that largely hydroxyl-free ionically modified polyurethane and/or polyurethane polyurea dispersions are obtained with an ionic group content of from 1.5 to 50, preferably from 3.0 to 35 and more preferably from 3.5 to 15 mmol/100 g solids and the OH group content corresponds to an OH number of less than 6 mg KOH/g, preferably less than 2.5 mg KOH/g.

In a likewise particularly preferred embodiment of the invention the above-mentioned starting materials are calculated such as to give largely hydroxyl-free ionically modified polyurethane and/or polyurethane polyurea dispersions which in addition to ionic groups contain from 0.1 to 20% by weight, preferably from 0.5 to 10% by weight and more preferably from 0.9 to 4% by weight, based on solids, of nonionically hydrophilic groups in the form of polyethylene oxide units.

For the preparation of inventive component B) first of all a OH— or NH-functional polymer (polyurethane resin) is prepared and is then converted into an aqueous dispersion.

The polymer preparation takes place normally in analogy to EP-A 0 355 682, p. 4, lines 39-45. In this procedure, one or more polyisocyanates as per the above definition of component A4) and one or more compounds of the above definitions of components A1)-A3) and A6) are used to prepare an isocyanate-functional prepolymer and in a second reaction step, by reaction with compounds as per the above definitions of components A2) and/or A5) in a non-aqueous medium, an OH- and/or NH-functional polyurethane is obtained.

Alternatively the OH— and/or NH-containing polyurethane resin can be prepared, as described for example in EP-A 0 427 028, p.4, line 54-p. 5, line 1, directly by reacting compounds as per the above definitions of components A1) to A6) in a non-aqueous medium.

The OH component as per the definition of A1) that is used for the preparation of component B) can, but need not necessarily, be subjected to a distillation step like A1) under reduced pressure. Distillation conditions set are the same conditions as described above.

The preparation of the polyurethane resin B) by reaction of the abovementioned compounds is normally conducted at temperatures from 0° C. to 140° C., preferably 50-130° C., more preferably 70-110° C., depending on the reactivity of the isocyanate used. In addition it is also possible to use suitable catalysts, such as are customary in polyurethane chemistry. Examples are tertiary amines such as triethylamine, or diazobicyclooctane, organotin compounds such as dibutyltin oxide, dibutyltin dilaurate or tin bis(2-ethylhexanoate), or other organometallic compounds.

The polyurethane resin is preferably prepared in the presence of isocyanate-inert solvent. Particularly suitable for this purpose are solvents which are compatible with water, such as ethers, ketones and esters, for example, and also N-methylpyrrolidone. The amount of these solvents advantageously does not exceed 30% by weight and is preferably situated in the range from 5 to 25% by weight, based in each case on the sum of polyurethane resin B) and solvents.

The acid groups incorporated in the polyurethane resin B) can be neutralized by addition of base. Suitable bases are amines or inorganic bases, such as ammonia or sodium or potassium hydroxide. Preference is given to tertiary amines with or without OH groups, such as, for example, trialkylamines having 1 to 12, preferably 1 to 6, carbon atoms in each alkyl radical. Suitable examples include trimethylamine, triethylamine, methyldiethylamine, tripropylamine, diisopropyl-ethylamine or dialkylmonoalkanolamines, alkyldialkanolamines and trialkanol-amines. A preferred alkanolamine is dimethylethanolamine The neutralizing agent is generally used in a molar ratio with respect to the acid groups of the prepolymer of from about 0.3:1 to 1.3:1, preferably from about 0.4:1 to 1:1.

The neutralization of the COOH groups is conducted at temperatures from room temperature to +80° C., preferably from 40 to 80° C. and can take place before, during or following the resin preparation. Preferably the neutralizing step is carried out following the preparation.

In the subsequent stage the hydroxy-functional polyurethane resin is converted into an aqueous dispersion by addition of water or by introducing it into water.

The aqueous polyurethane resin dispersions (compounds of the component B)) obtainable in accordance with the process described in the foregoing posses in general a number-average molecular weight Mₙ of 1000 to 30 000 daltons, preferably from 1500 to 10 000 daltons, an acid number of from 10 to 80 mg KOH/g, preferably from 15 to 40 mg KOH/g and an OH content of 0.5-5% by weight, preferably 1.0-3.5% by weight.

Through combination with suitable crosslinkers C) it is possible, in accordance with the reactivity or, where appropriate, blocking of the crosslinkers, to prepare not only one-component coating materials but also two-component coating materials.

By one-component coating materials in the sense of the present invention are meant coating compositions where binder component and crosslinker component can be stored together without a crosslinking reaction taking place to any marked extent or any extent detrimental to the subsequent application. The crosslinking reaction takes place only at the time of application, following activation of the crosslinker. This activation can be brought about by means, for example, of an increase in temperature.

By two-component coating materials in the sense of the present invention are meant coating compositions for which binder component and crosslinker component have to be stored in separate vessels owing to their high reactivity. The two components are only mixed shortly before application, when they react generally without additional activation.

In order to accelerate the crosslinking reaction it is also possible, however, to use catalysts or to employ elevated temperatures. Examples of suitable crosslinkers include polyisocyanate crosslinkers, amide- and amine-formaldehyde resins, phenolic resins, aldehydes and ketone resins, such as phenyl-formaldehyde resins, resoles, furan resins, urea resins, carbamate resins, triazine resins, melamine resins, benzoguanamine resins, cyanimide resins, aniline resins, as are described in “Lackkunstharze”, H. Wagner, H. F. Sarx, Carl Hanser Verlag Munich, 1971.

As crosslinkers C) it is preferred to use polyisocyanates having free isocyanate groups, since the aqueous polyurethane coating materials obtained display a particularly high level of technical coatings properties. Examples of suitable crosslinkers C) include paint polyisocyanates such as polyisocyanates containing uretdione, biuret, isocyanurate or iminooxadiazinedione groups and prepared from hexamethylene diisocyanate, 1-isocyanato-3,3,5-trimethyl-5-isocyanatomethyl-cyclohexane (IPDI) or 2,4′- and/or 4,4′-diisocyanatodicyclohexylmethane, as are described, for example, in J. Prakt. Chem./Chem. Ztg. 1994, 336, 185-200. Preferred use in this context is made of the low-viscosity types as described in, for example, in EP-A 0 798 299 or DE-A 198 002 86. Also suitable, albeit less preferred, are paint polyisocyanates which contain urethane groups and are based on 2,4- and/or 2,6-diisocyanatotoluene or 1-isocyanato-3,3,5-trimethyl-5-isocyanatomethylcyclohexane on the one hand and low molecular mass polyhydroxyl compounds such as trimethylolpropane, the isomeric propanediols or butanediols, or any desired mixtures of such polyhydroxyl compounds, on the other.

The said compounds containing free isocyanate groups may where appropriate be converted into less reactive derivatives by reaction with blocking agents, these less reactive derivatives then undergoing reaction only following activation—at elevated temperatures, for example. Examples of suitable blocking agents for these polyisocyanates include monohydric alcohols such as methanol, ethanol, butanol, hexanol, cyclohexanol and benzyl alcohol, oximes such as acetoxime, methyl ethyl ketoxime and cyclohexanone oxime, lactams such as ε-caprolactam, phenols, amines such as diisopropylamine, benzyl-tert-butylamine or dibutyl-amine, dimethylpyrazole or triazole, and dimethyl malonate, diethyl malonate or dibutyl malonate or cyclopentanone carboxyalkyl esters.

Preference is given to the use of low-viscosity, hydrophobic or hydrophilicized polyisocyanates containing free isocyanate groups and based on aliphatic, cycloaliphatic, araliphatic and/or aromatic isocyanates, more preferably on aliphatic or cycloaliphatic isocyanates, since in this way it is possible to achieve a particularly high resistance level in the coating film. The advantages of the binder dispersions of the invention are manifested most clearly in combination with these crosslinkers. These polyisocyanates generally have a viscosity at 23° C. of from 10 to 3500 mPas. If necessary the polyisocyanates can be employed as a blend with small amounts of inert solvents in order to lower the viscosity to a figure within the stated range. Triisocyanatononane as well can be used alone or in mixtures as crosslinker component C).

The components A) and B) described here are generally sufficiently hydrophilic, so that the dispersibility of the crosslinkers C), where the substances in question are not water-soluble or water-dispersible in any case, is ensured.

Additionally, however, it is possible to hydrophilicize the crosslinker C). Water-soluble soluble or dispersible, optionally blocked polyisocyanates of this kind are obtainable, for example, by modification with carboxylate, sulphonate and/or polyethylene oxide groups and/or polyethylene oxide/polypropylene oxide groups.

Hydrophilicization of the polyisocyanates C) is possible, for example, through reaction with deficit amounts of monohydric, hydrophilic polyether alcohols. The preparation of hydrophilicized polyisocyanates of this kind is described in, for example, EP-A 0 540 985, p. 3, line 55-p. 4 line 5. Also suitable are the poly-isocyanates containing allophanate groups that are described in EP-A-959087, p. 3 lines 39-51, which are prepared by reacting low-monomer-containing polyiso-cyanates with polyethylene oxide polyether alcohols under allophanatization conditions. Also suitable are the water-dispersible polyisocyanate mixtures described in DE-A 100 078 21, p. 2 line 66-p. 3 line 5, based on triisocy-anatononane, and also polyisocyanates hydrophilicized with ionic groups (sulphonate groups, phosphonate groups), as described in, for example, DE-A 10024624, p. 3 lines 13-33. Hydrophilicization through addition of commercially customary emulsifiers is likewise possible.

It will be appreciated that the use of mixtures of different crosslinker resins C) is also suitable in principle.

As optional components D) it is possible to use customary coatings auxiliaries and additives, which are added both to the aqueous components A) and B) before, during or after their preparation and also to the crosslinker component C). Examples of auxiliaries and additives of this kind include defoamers, thickeners, pigments, dispersing assistants, matting agents, catalysts, antiskinning agents, anti-settling agents or emulsifiers, and also additives which may enhance the desired soft feel effect as well as mixtures or combinations thereof.

Besides the inventively essential components A) to D) the aqueous coating compositions of the invention may optionally also comprise other binders or dispersions, based for example on polyesters, polyurethanes, polyethers, polyepoxides or polyacrylates, and, if desired, pigments and other auxiliaries and additives known in the coatings industry.

The invention further provides for the use of the aqueous coating compositions of the invention as paint and coating systems, for example, for surfaces of mineral building materials, for coating and sealing of wood and wood-based materials, for coating of metallic surfaces (metal coating), for coating and painting asphaltic or bituminous coverings, for coating and sealing of various surfaces of plastics (plastics coating) and also for high-gloss varnishes. They are particularly suitable, however, for producing soft feel effect coatings which ensure good solvent resistance and, in particular, good resistance to suncream (suntan lotion test). Such coating compositions are preferably used in plastics coating or in wood coating, where curing takes place normally at temperatures between room temperature and 130° C. The two-component technology with non-blocked polyisocyanate crosslinkers allows the use of comparatively low curing temperatures within the abovementioned range.

The aqueous coating compositions of the invention are usually used in single-coat coating materials or in the clearcoat or topcoat film (topmost film) of multi-coat systems.

The coating can be produced by any of a wide variety of spraying methods such as, for example, compressed-air spraying, airless spraying or electrostatic spraying methods, using one-component or, where appropriate, two-component spraying units. The paints and coating compositions comprising the binder dispersions of the invention can also be applied, however, by other methods, for example by brushing, rolling or knifecoating.

### EXAMPLES

All of the chemicals used were obtained commercially and used without further purification.

All percentages are to be understood as percent by weight unless otherwise indicated.

The average particle sizes were measured by means of laser correlation spectroscopy on a Zetasizer 1000 from Malvern Instruments Ltd, Worcestershire, GB.

The efflux viscosity of the dispersions was determined in accordance with DIN EN ISO 2431 by means of a DIN flow cup with 4 mm nozzle (Ford 4 mm cup).

The viscosity measurement was made in accordance with DIN EN ISO 3219 in the form of rotational viscosity at a shear rate of 40 s⁻¹ on a Viscolab® LC3 from Paar Physica, Ashland, USA.

Polyurethane dispersion I (PUD I): Bayhydrol® PR 240 from Bayer AG, Leverkusen: hydroxyl-free aliphatic polyesterpolyurethane dispersion having a solids content of 40±1% by weight, a pH of about 7.0 and an efflux time<70 s at 23° C.

Polyurethane dispersion II (PUD II): Bayhydrol® VP LS 2305 from Bayer AG, Leverkusen: hydroxyl-free aliphatic polyesterpolyurethane dispersion having a solids content of 40±1% by weight, a pH of 7.0 and an efflux time of 20 s at 23° C.

Polyurethane dispersion III (PUD III): Bayhydrol® XP 2429 from Bayer AG, Leverkusen: hydroxyl-functional aliphatic polyesterpolyurethane dispersion having a solids content of 55±2% by weight, a pH of 7.0 and a viscosity of 600 mPas at 23° C.

Polyisocyanate I (PIC I): Bayhydur® 3100 from Bayer AG, Leverkusen: aliphatic polyisocyanate having a solids content of 100% by weight, a viscosity of 3800 mPas at 23° C. and an isocyanate content of 17.4%.

### Example 1

### Polyesterdiol I

5400 g of a mixed ester of adipic acid, hexanediol and neopentyl glycol with an OH number of 66 were freed from low-boiling components by means of a conventional laboratory thin-film evaporator at an evaporator temperature of 200° C. under a vacuum of 0.1 mbar with a metering rate of 300 g/h. The condensation temperature was 50° C.

This gave 5100 g of polyesterdiol I with an OH number of 56.

### Example 2

### Polyesterpolyol II

5000 g of a caprolactone-hexanediol polycarbonatediol mixed ester having a number-average molecular weight of 2000 da (OH number=56; Desmophen® VP LS 2391, Bayer AG, Leverkusen, Del.) were freed from low-boiling components by means of a conventional laboratory thin-film evaporator at an evaporator temperature of 180° C., under a vacuum of 0.1 mbar with a metering rate of 300 g/h. The condensation temperature was 50° C.

This gave 4920 g of polyesterdiol II with an OH number of 52.

### Example 3

### Polyesterpolyol I

A 15 l reaction vessel with stirrer, heating apparatus and water separator with cooling apparatus was charged with 1281 g of phthalic anhydride, 5058 g of adipic acid, 6387 g of hexane-1,6-diol and 675 g of neopentyl glycol and this initial charge was heated to 140° C. under nitrogen in one hour. In a further 9 hours it was heated to 220° C. and subjected to condensation at this temperature until an acid number of less than 3 had been reached. The resulting polyesterpolyol had a viscosity (determined as the efflux time of an 80% strength solution of polyester in methoxypropyl acetate in the DIN 4 cup at 23° C.) of 54 seconds and an OH number of 160 mg KOH/g.

### Example 4

A 3.6 L pot with plane ground joints, equipped with heating, reflux condenser and stirrer, was charged with 420.5 g of polyesterdiol I, which was dewatered at 20 mbar and 100° C. for 60 minutes. At 65° C. 4.7 g of hexane-1,6-diol were added and the mixture was stirred until completely homogeneous. Subsequently 75.5 g of hexamethylene diisocyanate were added and, after the exothermic reaction had subsided, the mixture was heated to 110° C. After a reaction time of 7 hours a constant isocyanate content of 2.8% (theoretical=3.3%) was found. The prepolymer was dissolved in 900 g of anhydrous acetone and cooled to 38° C. A top-mounted dropping funnel was used to add a solution of 11.3 g of Na N-(2-aminoethyl)-2-aminoethanesulfonate and 4.3 g of ethylenediamine in 150 g of distilled water. After a reaction time of 15 minutes the product was dispersed with 625 g of distilled water. Removal of the acetone under vacuum gave a fine dispersion with a solids content of 40±1% by weight and a pH of 7.0.

### Example 5

A 3.6 L pot with plain ground joints, equipped with heating, reflux condenser and stirrer, was charged with 1700 g of polyesterdiol I and 58.5 g of a polyether monoalcohol made from n-butanol, ethylene oxide and propylene oxide (in a molar ratio of 83:17) with an OH number of 25 and this initial charge was dewatered at 20 mbar and 100° C. for 60 minutes. The vacuum was subsequently broken with nitrogen. Then 250 g of 1-isocyanato-3,3,5-trimethyl-5-isocyanatomethyl-cyclohexane (isophorone diisocyanate) and 190 g of hexamethylene diisocyanate were added and the mixture was stirred at 100° C. until it had an isocyanate content of 4.75%. After the mixture had been cooled to 50-60° C., 3900 g of anhydrous acetone were added. The acetone solution was cooled to 45° C. Subsequently a mixture of 107 g of 1-amino-3,3,5-trimethyl-5-aminomethyl-cyclohexane (IPDA) in 210 g of anhydrous acetone was run in. After the exothermic reaction had subsided, 22 g of sodium N-(2-aminoethyl)-2-aminoethanesulphonate and 5 g of hydrazine monohydrate in solution in 250 g of water were added. After 10 minutes of subsequent stirring, 3500 g of water were introduced slowly with intensive stirring. A bluish white dispersion of the solids formed, in a mixture of water and acetone. Following the removal of the acetone by distillation an aqueous dispersion remained with a solids content of 40±1% by weight. Measurement of the particle diameter by means of laser correlation gives a value of 210 nm. The dispersion has an efflux time of 22 seconds.

### Example 6

A 6 l reaction vessel with cooling, heating and stirring apparatus was charged under nitrogen with 1170 g of polyesterpolyol I and this initial charge was heated together with 1140 g of polyesterdiol II, 90 g of trimethylolpropane, 120 g of dimethylolpropionic acid, 125 g of N-methylpyrrolidone and 3.8 g of tin(II) octoate to 130° C. and homogenized for 30 minutes. It was then cooled to 80° C., 480 g of hexamethylene diisocyanate were added with vigorous stirring, and the mixture was heated to 140° C. using the exothermic heat and maintained at this temperature until NCO groups were no longer detectable.

Subsequently the resultant polyurethane was cooled to 90°-100° C., 39 g of dimethylethanolamine (degree of neutralization 50%) were added and the mixture was homogenized for 15 minutes and dispersed with 2270 g of demineralized water. The aqueous polyurethane resin dispersion thus obtained had an OH content (in 100% form) of 1.4%, an acid number (in 100% form) of 18, an average particle size of 120 nm and a viscosity of approximately 1700 mPas (23° C.; D=40 s⁻¹) at a solids content of 51.3% by weight.

### Examples 7 to 13

VOC and fog values determined in accordance with recommendation 278 “thermodesorption analysis of organic emissions for characterizing nonmetallic automotive materials” of the Verband der deutschen Automobilindustrie [German car industry association]:

| Example | 7 | 8 | 9 | 10 | 11 | 12 | 13 |
|---|---|---|---|---|---|---|---|
| PUD I | 100 | | | | | | |
| PUD II | | 100 | | | 52.5 | | |
| Example 4 | | | 100 | | | | |
| Example 5 | | | | 100 | | 52.5 | 52.5 |
| PUD III | | | | | 40.5 | 40.5 | |
| Example 6 | | | | | | | 40.5 |
| PIC I | | | | | 7.0 | 7.0 | 7.0 |
| Film thickness | 76 | 53 | 59 | 59 | 76 | 84 | 73 |
| VOC [mg/kg] | 324 | 233 | 4 | 8 | 211 | 111 | 61 |
| Fog [mg/kg] | 526 | 526 | 10 | 14 | 480 | 334 | 213 |

Quantities in parts by weight.

If the VOC and fog values for Examples 7 and 8 are compared with those for Examples 9 and 10, the improvement of the dispersions of the invention as compared with the prior art becomes striking. Even in the case of the standard system for aqueous 2K soft feel coatings (Example 11) replacing some (Example 12) or all (Example 13) of the synthesis components by components according to the invention significantly reduces the VOC and fog value.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous coating compositions comprising
A) at least one aqueous formulation of an ionically modified, substantially hydroxyl-free polyurethane and/or polyurethaneurea,
B) at least one aqueous formulation of an ionically modified, hydroxyl-containing polyurethane and/or polyurethaneurea, and
C) at least one crosslinker,
wherein component A) is synthesized from
A1) one or more polyhydroxyl compounds having a number-average molecular weight (Mₙ)≧500 daltons and an average OH functionality of ≧1.5, substantially free of components volatile at a temperature ≧150° C. and a pressure ≦10 mbar,
A2) optionally one or more polyhydroxyl compounds having a number-average molecular weight (Mₙ) of from 62 to 499 daltons and an OH functionality of ≧2,
A3) optionally one or more hydrophilic compounds having an ethylene oxide content of 50% by weight and a number-average molecular weight (Mₙ) of more than 400 daltons, which contain at least one NCO-reactive group,
A4) one or more polyisocyanates,
A5) optionally one or more aliphatic polyamines having a number-average molecular weight (Mₙ) of from 60 to 300 daltons and at least two primary or secondary amino groups or hydrazine and
A6) one or more compounds containing at least one NCO-reactive hydrogen atom or at least one NCO group and simultaneously at least one ionic or potentially ionic group and different from the aforementioned compounds of compounds A1)-A5).

2. The aqueous coating compositions according to claim 1, wherein organic compounds based on polyester, polylactone or polycarbonate having a number-average molecular weight of 500-10,000 daltons and an average OH functionality of from 1.5 to 6 are used as compounds of component A1).

3. The aqueous coating compositions according to claim 1, wherein low molecular mass polyols with a number-average molecular weight of from 62 to 499 daltons are used as compounds of component A2.

4. The aqueous coating compositions according to claim 1, wherein the compounds of component A3) are monohydroxy-functional polyethers based on ethylene oxide or on ethylene oxide-propylene oxide.

5. The aqueous coating compositions according to claim 1, wherein component A6) compounds having two hydroxyl primary or secondary amino groups and also one anionic or potentially anionic group are used.

6. Coatings obtainable from aqueous coating compositions according to claim 1.

7. Substrates coated with coatings according to claim 6.

8. Soft feel coating materials comprising the polyhydroxy compounds according to claim 1, component A1).

9. The aqueous coating compositions of claim 1, comprising D) auxiliaries and additives selected from the group consisting of defoamers, thickeners, pigments, dispersing assistants, matting agents, catalysts, antiskinning agents, anti-settling agents, emulsifiers and mixtures or combinations thereof.

10. The aqueous coating compositions according to claim 2, wherein low molecular mass polyols with a number-average molecular weight of from 62 to 499 daltons are used as compounds of component A2.

11. The aqueous coating compositions according to claim 2, wherein the compounds of component A3) are monohydroxy-functional polyethers based on ethylene oxide or on ethylene oxide-propylene oxide.

12. The aqueous coating compositions according to claim 3, wherein the compounds of component A3) are monohydroxy-functional polyethers based on ethylene oxide or on ethylene oxide-propylene oxide.

13. The aqueous coating compositions according to claim 2, wherein component A6) compounds having two hydroxyl primary or secondary amino groups and also one anionic or potentially anionic group are used.

14. The aqueous coating compositions according to claim 3, wherein component A6) compounds having two hydroxyl primary or secondary amino groups and also one anionic or potentially anionic group are used.

15. The aqueous coating compositions according to claim 4, wherein component A6) compounds having two hydroxyl primary or secondary amino groups and also one anionic or potentially anionic group are used.
